(19) United States
(12) Patent Application Publication
(10) Pub. No.: US 2022/0262102 A1
(43) Pub. Date: Aug. 18, 2022

(54) METHOD AND DEVICE FOR MONITORING LICENSE PLATE RECOGNITION RATE, AND COMPUTER-READABLE STORAGE MEDIUM

(71) Applicant: ParkingCloud Co., Ltd., Seoul (KR)

(72) Inventors: Sang Yong SHIN, Seoul (KR); Won Jin HEO, Seoul (KR)

(73) Assignee: ParkingCloud Co., Ltd., Seoul (KR)

(21) Appl. No.: 17/628,819

(22) PCT Filed: May 20, 2020
(86) PCT No.: PCT/KR2020/006602

§ 371 Date: Jan. 20, 2022

(30) Foreign Application Priority Data
Jul. 23, 2019 (KR) 10-2019-0088928

(51) Int. Cl. G06V 10/776; G06V 20/62

(52) U.S. Cl. CPC G06V 10/776; G06V 20/625

(57) ABSTRACT

A method performed by at least one computing device for monitoring a license plate recognition rate according to an embodiment includes acquiring a plurality of position information indicating positions of license plate areas in a plurality of images, calculating a score indicating the degree of distribution of the license plate areas in the entire area of the image by using the acquired plurality of position information, and generating a notification indicating that the license plate recognition rate is lower than a reference level when the score is higher than a threshold value. Various other embodiments are also possible.

### TECHNICAL FIELD

The present disclosure relates to a method, device and computer-readable storage medium for monitoring a license plate recognition rate.

### BACKGROUND

Unless otherwise indicated herein, the materials described in this section are not prior art to the claims in this application and are not admitted as prior art by inclusion in this section.

In order to recognize a vehicle license plate number, it is necessary to acquire an image including a license plate and analyze the acquired image. Due to the improvement of computer vision technology, License Plate Recognition (LPR) technology, which recognizes vehicle license plate numbers from images including license plates, has high accuracy rates. However, the image including the license plate is acquired from a moving vehicle and is not taken in a controlled environment such as a studio, and, thus, if the acquired image is of too low quality to be complemented with the computer vision technology, the license plate cannot be recognized or may be misrecognized. That is, despite the advancement of the LPR technology, environmental factors such as the location of a camera photographing a vehicle, road environment, and brightness may have a great influence on a license plate recognition rate.

At the time of installation of a license plate recognition system in a parking lot, it is difficult to predict environmental factors that may influence the license plate recognition rate. Accordingly, there is a need for a service of monitoring the license plate recognition rate after installation to take preemptive measures before users of the license plate recognition system in the parking lot express dissatisfaction.

### DISCLOSURE OF THE INVENTION

Based on the above discussion, the present disclosure provides a method, device and computer-readable medium for providing a service of monitoring a license plate recognition rate in a license plate recognition system.

Also, the present disclosure provides a method, device and computer-readable medium for generating a plurality of position information of license plate areas in a plurality of images acquired by a license plate recognition system and providing a score indicating the degree of distribution of license plate areas by using the generated plurality of position information.

A method for monitoring a license plate recognition rate that is performed by at least one computing device according to an embodiment includes: acquiring a plurality of position information indicating positions of license plate areas in a plurality of images; calculating a score indicating the degree of distribution of license plate areas in the entire area of the image by using the acquired plurality of position information; and generating a notification indicating that the license plate recognition rate is lower than a reference level when the score is higher than a threshold value.

The method for monitoring a license plate recognition rate according to an embodiment may further include: further acquiring position information of a new image; and updating the score by using the position information of the new image.

In the method for monitoring a license plate recognition rate according to an embodiment, the score may be calculated by using a plurality of position information recently acquired as many as a preset number.

In the method for monitoring a license plate recognition rate according to an embodiment, the score may be calculated based on at least one of the degree of dispersion, density, and size and slope of the license plate areas.

The method for monitoring a license plate recognition rate according to an embodiment may further include: taking the plurality of images including the license plate areas; extracting the license plate area from each of the plurality of images; and recognizing a vehicle license plate number from the extracted license plate area, and the plurality of position information indicating the positions of the license plate areas may be generated in the process of extracting the license plate areas from the plurality of images.

A server for monitoring a license plate recognition rate according to an embodiment includes: at least one processor connected to a photographing device; and a memory operatively connected to the at least one processor, and the memory includes instructions that, when executed, causes the at least one processor: to acquire a plurality of position information indicating positions of license plate areas in a plurality of images; to calculate a score indicating the degree of distribution of license plate areas in the entire area of the image by using the acquired plurality of position information; and to generate a notification indicating that the license plate recognition rate is lower than a reference level when the score is higher than a threshold value.

A computer program stored in a computer-readable recording medium for monitoring a license plate recognition rate according to an embodiment includes one or more computer-executable instructions that, when executed by a computing device, cause the computing device to perform: acquiring a plurality of position information indicating positions of license plate areas in a plurality of images; calculating a score indicating the degree of distribution of license plate areas in the entire area of the image by using the acquired plurality of position information; and transmitting a notification indicating that the score is higher than a threshold value when the score is higher than the threshold value. The foregoing summary is illustrative only and is not intended to be in any way limiting. In addition to the illustrative embodiments and features described above, further embodiments and features will become apparent by reference to the drawings and the following detailed description.

The device, method and computer-readable storage medium according to various embodiments of the present disclosure can provide an improved parking management system configured to notify in advance the presence of an environmental factor that degrades a license plate recognition rate by monitoring the license plate recognition rate so that a user having a license plate recognition system can take quick action accordingly.

The effects to be achieved by the present disclosure are not limited to the above-described effects. Although not described herein, other effects to be achieved by the present disclosure can be clearly understood by a person with ordinary skill in the art from the following descriptions.

### BRIEF DESCRIPTION OF THE DRAWINGS

FIG. 1 is a block diagram illustrating a parking management system for monitoring a license plate recognition rate, in accordance with an embodiment.

FIG. 2 illustrates an example where position information of a license plate area is acquired in a process of recognizing a license plate, in accordance with an embodiment.

FIG. 3 illustrates examples where the degree of distribution of license plate areas is visualized by using the acquired position information.

FIG. 4 illustrates another example where the degree of distribution of license plate areas is visualized by using the acquired position information.

FIG. 5 is an exemplary flowchart for describing an operation process performed to monitor a license plate recognition rate, in accordance with an embodiment.

FIG. 6 is a conceptual diagram illustrating an exemplary environment where an image of a license plate is taken when a vehicle enters a parking lot.

FIG. 7 illustrates an exemplary computer program product that can be used for monitoring a license plate recognition rate, in accordance with an embodiment.

### BEST MODE FOR CARRYING OUT THE INVENTION

The terms used herein are used only to describe specific examples, but do not intend to limit the present disclosure. A singular expression includes a plural expression unless it is clearly construed in a different way in the context. All terms including technical and scientific terms used herein have the same meaning as commonly understood by a person with ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. In some cases, even terms defined in the present disclosure should not be interpreted as excluding embodiments of the present disclosure.

The foregoing features and other features of the present disclosure will be sufficiently apparent from the following descriptions with reference to the accompanying drawings. These drawings merely illustrate several exemplary embodiments in accordance with the present disclosure. Therefore, they should not be understood as limiting the present disclosure. The present disclosure will be described in more detail with reference to the accompanying drawings.

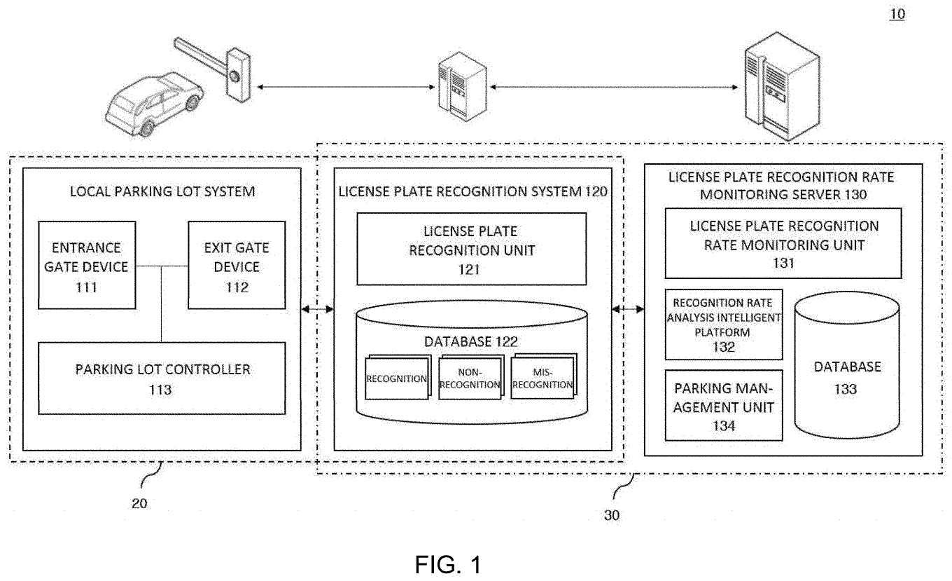

FIG. 1 is a block diagram illustrating a parking management system for monitoring a license plate recognition rate, in accordance with an embodiment. FIG. 1 illustrates, as some of devices for monitoring a license plate recognition rate in a license plate recognition rate monitoring system 10, a local parking lot system 110, a license plate recognition system 120 and a license plate recognition rate monitoring server 130. Although FIG. 1 illustrates only one local parking lot system 110, license plate recognition rate monitoring system 10 may include a plurality of parking lot systems and thus may further include a plurality of local parking lot systems 110 and/or a plurality of license plate recognition systems 120.

Local parking lot system 110 may be a system installed for each parking lot within a predetermined region to manage parking lots within a predetermined zone. Parking lot system 110 may include an entrance gate device 111, an exit gate device 112 and a parking lot controller 113.

Entrance gate device 111 is provided to manage vehicles entering a parking lot, and may include a photographing device configured to photograph a license plate of an incoming vehicle and a barrier configured to control entry of vehicles. Exit gate device 112 is provided to manage vehicles exiting from the parking lot, and may include a photographing device configured to photograph a license plate of an outgoing vehicle and a barrier configured to control exit of vehicles. For example, the photographing devices (e.g., cameras) included entrance gate device 111 and exit gate device 112 may photograph the front view/and or the rear view (e.g., still image or video) of a vehicle. Parking lot controller 113 may be configured to control the barrier based on whether a vehicle license plate number on a license plate of a vehicle entering or exiting from the parking lot is recognized by the photographing device. For example, parking lot controller 113 may be configured to acquire vehicle images including a license plate from entrance gate device 111 and exit gate device 112, transmit the acquired images to license plate recognition system 120, and control the barrier depending on the result of recognition of the license plate acquired from license plate recognition system 120.

License plate recognition system 120 may be configured to analyze a vehicle image received from local parking lot system 110 and recognize a vehicle license plate number of the vehicle. License plate recognition system 120 may include a license plate recognition unit 121 and a database 122. License plate recognition unit 121 may extract a license plate area from the vehicle image and recognize a vehicle license plate number from the license plate area. License plate recognition unit 121 may generate position information of the license plate area while extracting the license plate area. License plate recognition system 120 may transmit the generated position information to license plate recognition rate monitoring server 130.

In an embodiment, license plate recognition system 120 may transmit the generated position information to license plate recognition rate monitoring server 130. License plate recognition system 120 may generate position information whenever a vehicle image is acquired, i.e., whenever a license plate recognition event occurs, and may transmit the position information to license plate recognition rate monitoring server 130. In another embodiment, license plate recognition system 120 may accumulate the generated position information in database 122, and may transmit a plurality of position information to license plate recognition rate monitoring server 130 when accumulating the position information as many as a preset number. The position information may be transmitted at the request of license plate recognition rate monitoring server 130, or may be transmitted at predetermined time intervals.

There may be a case where a vehicle license plate number is not recognized from a vehicle image by license plate recognition system 120, i.e., non-recognition or misrecognition of the vehicle license plate number may occur. In an embodiment, license plate recognition system 120 may classify and store a vehicle image and/or position information of a license plate area in the vehicle image depending on the success or failure of license plate recognition. For example, a vehicle image from which a vehicle license plate number is recognized may be stored in a recognition storage unit included in database 122 (or memory), a vehicle image from which a vehicle license plate number is not recognized may be stored in a non-recognition storage unit, and a vehicle image from which a vehicle license plate number is misrecognized may be stored in a misrecognition storage unit. For another example, license plate recognition unit 121 may label a vehicle image and/or position information of a license plate area in the vehicle image with a license plate recognition result. The vehicle image and/or position information of the license plate area labeled or classified and stored in database 122 may be used to analyze environmental factors that influence non-recognition or misrecognition of a vehicle license plate number.

In an embodiment, license plate recognition rate monitoring server 130 may monitor a license plate recognition rate by using position information of a license plate area received from license plate recognition system 120. The license plate recognition rate may be monitored for each of entrance gate device 111 and exit gate device 112. License plate recognition rate monitoring server 130 may include a license plate recognition rate monitoring unit 131, a recognition rate analysis intelligent platform 132 and a database 133.

License plate recognition rate monitoring unit 131 may identify a license plate recognition rate by using a plurality of position information received from license plate recognition system 120. In an embodiment, the license plate recognition rate may be identified based on the degree of distribution of license plate areas in the entire area of the vehicle image. For example, license plate recognition rate monitoring unit 131 may calculate a score indicating the degree of distribution of a plurality of license plate areas. For another example, license plate recognition rate monitoring unit 131 may generate data that visualize the degree of distribution of a plurality of license plate areas. Meanwhile, the score is a numerical value of a license plate recognition rate of the corresponding parking lot and thus may be referred to as a Parking-Score (P-Score) or a vehicle license plate number recognition environment score.

In an embodiment, license plate recognition rate monitoring unit 131 may identify a license plate recognition rate whenever receiving position information of a vehicle image from license plate recognition system 120. That is, license plate recognition rate monitoring unit 131 can identify a license plate recognition rate in real-time. In another embodiment, license plate recognition rate monitoring unit 131 may also identify a license plate recognition rate whenever position information of vehicle images received from license plate recognition system 120 is accumulated as many as a preset number. In yet another embodiment, license plate recognition rate monitoring unit 131 may identify a license plate recognition rate at the request of a user.

In an embodiment, when license plate recognition rate monitoring unit 131 determines that the identified license plate recognition rate is lower than a reference level, license plate recognition rate monitoring unit 131 may generate a notification indicating that the license plate recognition rate is lower than the reference level. The identified license plate recognition rate is determined lower than the reference level when the score indicating the degree of distribution of license plate areas is higher than a reference score (threshold value). The opposite is also possible. The notification indicating that the license plate recognition rate is lower than the reference level may be output by displaying a message, a notification sound, the calculated score or the visualized data. The notification may be output through an internal output device, an external output device or a user device connected to license plate recognition rate monitoring server 130. A method or configuration of license plate recognition rate monitoring unit 131 to determine that the license plate recognition rate is lower than the reference level will be described in detail below.

In an embodiment, when license plate recognition rate monitoring unit 131 determines that the license plate recognition rate is lower than the reference level, recognition rate analysis intelligent platform 132 may analyze a cause of a low license plate recognition rate. Recognition rate analysis intelligent platform 132 may be equipped with a rule-based system as an artificial intelligence system, or may be equipped with a neural network-based system (e.g., feedforward neural network (FNN), recurrent neural network (RNN), generative adversarial networks (GAN)). Otherwise, recognition rate analysis intelligent platform 132 may be equipped with a combination of the above or another artificial intelligence system.

In an embodiment, database 133 may store and accumulate the vehicle images received from license plate recognition system 120 and/or the position information of the license plate. The vehicle images and/or the position information of the license plate stored in database 133 may be used to perform the operations of license plate recognition rate monitoring unit 131 and recognition rate analysis intelligent platform 132.

In an embodiment, license plate recognition rate monitoring server 130 may further include a parking management unit 134. Parking management unit 134 may perform the operations necessary to provide a comprehensive parking service, such as checking whether a vehicle entering or exiting from a parking lot is parked, time, parking fee and whether a vehicle (parking lot user) has a membership subscription. Accordingly, parking management unit 134 may further receive information about entry time, exit time, vehicle type, etc. in addition to the vehicle images and/or the position information from local parking lot system 110 or license plate recognition system 120. Database 133 may further store information necessary for parking management unit 134 to provide a parking lot service, for example, identification information (e.g., parking lot ID), parking lot usage information (e.g., usage fee, location, time and number of parking surfaces). Accordingly, license plate recognition rate monitoring server 130 may be referred to as “central server”, “integrated server”, “customer service (CS) server”, “main server”, “LPR server” or other terms having the same meaning.

While described as independent components, local parking lot system 110, license plate recognition system 120 and license plate recognition rate monitoring server 130 included in license plate recognition rate monitoring system 10 as shown in FIG. 1 are may be implemented in other embodiments.

For example, local parking lot system 110 and license plate recognition system 120 may be installed in a parking lot region and may form a local system 20, and license plate recognition rate monitoring server 130 may be installed apart from local system 20. One of local parking lot system 110 and license plate recognition system 120 may be included as an internal component in the other system. The functions for recognizing a license plate may be generally performed by local system 20, and license plate recognition rate monitoring server 130 may receive images and/or license plate areas from local system 20 to monitor a recognition rate. Accordingly, local system 20 may be referred to as “local parking management system”, “local server” or other terms having the same meaning, and license plate recognition rate monitoring server 130 may be referred to as “central parking management system”, “central server”, “integrated server”, “customer service (CS) server”, “main server”, “LPR server” or other terms having the same meaning.

For another example, license plate recognition system 120 and license plate recognition rate monitoring server 130 may be installed in a region apart from a parking lot and may form a central system 30. In that case, local parking lot system 110 installed in the parking lot may transmit a vehicle image to central system 30, and central system 30 may recognize a license plate and monitor a recognition rate by using the received vehicle image. Central system 30 may transmit a license plate recognition result. That is, license plate recognition rate monitoring system 10 is composed of local parking lot system 110 and central system 30, and local parking lot system 110 may be referred to as “local parking management system”, “local server” or other terms having the same meaning, and central system 30 may be referred to as “central parking management system”, “central server”, “integrated server”, “customer service (CS) server”, “main server”, “LPR server” or other terms having the same meaning.

Also, in the present disclosure, license plate recognition system 120 and/or license plate recognition rate monitoring server 130 may be an application server, a standalone server, a web server and any computing device having data transmission/reception functions, data identification functions and data processing functions to perform the functions and operations described in the present disclosure, and may include at least one processor and a memory that stores instructions configured to cause the at least one processor to perform the above-described functions and operations.

Local parking lot system 110, license plate recognition system 120 and license plate recognition rate monitoring server 130 included in license plate recognition rate monitoring system 10 may mutually establish a direct (e.g., wired) communication channel or wireless communication channel and may transmit or receive data and signals through the established communication channel. To this end, each of local parking lot system 110, license plate recognition system 120 and license plate recognition rate monitoring server 130 included in license plate recognition rate monitoring system 10 may include a communication module. The communication module operates independently of the processor (e.g., application processor) included in the computing device and may include one or more communication processors that support direct (e.g., wired) communication or wireless communication. According to an embodiment, the communication module may include a wireless communication module (e.g., cellular communication module, short-range wireless communication module or global navigation satellite system (GNSS) communication module) or a wired communication module (e.g., local area network (LAN) communication module or power line communication module).

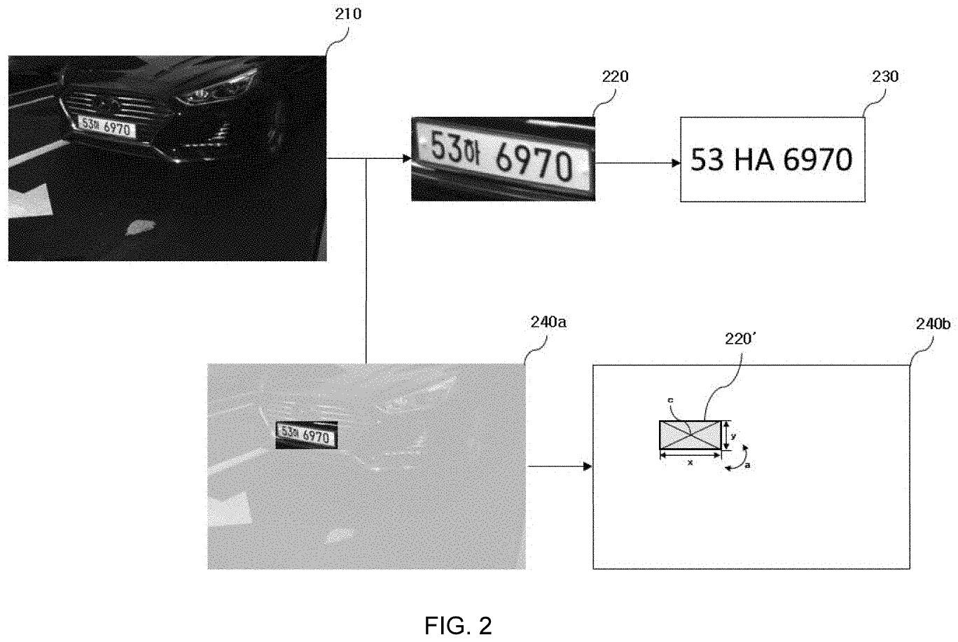

Also, local parking lot system 110, license plate recognition system 120 and license plate recognition rate monitoring server 130 included in license plate recognition rate monitoring system 10 may be connected to each other through a communication method (e.g., bus, general purpose input and output (GPIO), serial peripheral interface (SPI) or mobile industry processor interface (MIPI)) used between peripheral devices and may exchange signals (e.g., command or data) with each other. FIG. 2 illustrates an example where position information of a license plate area is acquired in a process of recognizing a license plate.

Referring to FIG. 2, license plate recognition unit 121 (or, license plate recognition system 120) may extract a license plate area 220 from a vehicle image 210 received from local parking lot system 110. License plate recognition system 120 may recognize a vehicle license plate number from the extracted license plate area 220 by using an OCR engine (e.g., Tesseract OCR Engine).

This merely illustrates a basic process of license plate recognition, and a detection and recognition algorithm applied with various image processing methods, such as feature point detection, matching, tracking, filtering and three-dimensional projection transformation, using an image processing library OpenCV can be added.

In an embodiment, vehicle license plate number license plate recognition unit 121 may generate position information of license plate area 220 in the process of extracting the license plate area 220 from vehicle image 210. The position information indicates a relative position of license plate area 220 with respect to the entire vehicle image 210, as observed in FIGS. 240a and 240b.

The position information may have various forms. For example, the position information may include coordinate data corresponding to four vertices of a license plate area 220′. For another example, the position information may include coordinate data of a center point c of license plate area 220′ and data about a horizontal length x, a vertical lengthy and a slope a.

In another embodiment, the position information may be generated in a different form depending on the shape of a license plate area. For example, the shape of the license plate area may be a pentagon or higher order polygon, and in that case, the position information may include five coordinate data corresponding to the vertices of the license plate area. For another example, when the shape of the license plate area is an elliptical shape, the position information may include vector data indicating this shape.

Referring again to FIG. 1, a method of monitoring a license plate recognition rate by license plate recognition rate monitoring unit 131 using the position information of the license plate areas will be described in detail.

License plate recognition rate monitoring unit 131 may calculate a score indicating the degree of influence of environmental factors on a license plate recognition rate by using the position information of the received license plate areas based on an arbitrary calculation method. The calculated score may be an index indicating a license plate recognition rate of a device, e.g., entrance gate device 111 or exit gate device 112, installed in a corresponding local parking lot.

For example, when the calculated score is equal to or lower than a reference score (threshold value), it may be determined that environmental factors of the parking lot do not influence a license plate recognition rate. When the calculated score is higher than the reference score (threshold value), it may be determined that the environmental factors of the parking lot influence the license plate recognition rate. When the calculated score is higher than the reference score (threshold value), this fact may be informed to parking lot users (e.g., parking lot manager, parking management service provider, etc.). Therefore, it is possible to suppress the occurrence of damage caused by non-recognition or misrecognition of a vehicle license plate number.

For another example, when the calculated score is equal to or lower than the reference score, it may be determined that the environmental factors influence the license plate recognition rate, and when it is higher than the reference score, it may be determined that the environmental factors do not influence the license plate recognition rate.

In an embodiment, license plate recognition rate monitoring unit 131 may calculate the degree of dispersion, density, and the uniformity of sizes and/or slopes of the license plate areas by using the received position information of the license plate areas. Then, license plate recognition rate monitoring unit 131 may numericalize (score) the license plate recognition rate by using at least one of the calculated degree of dispersion, density, and the uniformity of sizes and/or slopes of the license plate areas. In other words, license plate recognition rate monitoring unit 131 may calculate the degree of distribution of the license plate areas as a score by using the position information of the received license plate areas based on an arbitrary calculation method.

First, the factors that determine the license plate recognition rate will be described. When the license plate recognition rate is high, i.e., when the environmental factors do not significantly influence the acquisition of images, the license plate areas may be concentrated at a certain point in the entire area and the sizes and/or slopes of the license plate areas may be uniform. However, when the license plate recognition rate is low, i.e., when the environmental factors significantly influence the acquisition of images, the license plate areas may not be concentrated at a certain point but may be distributed in the entire area and the sizes and/or slopes of the license plate areas may not be uniform. Accordingly, the degree of dispersion or density of the license plate areas in the entire area, the uniformity of sizes and/or slopes of the license plate areas, etc. can be criteria.

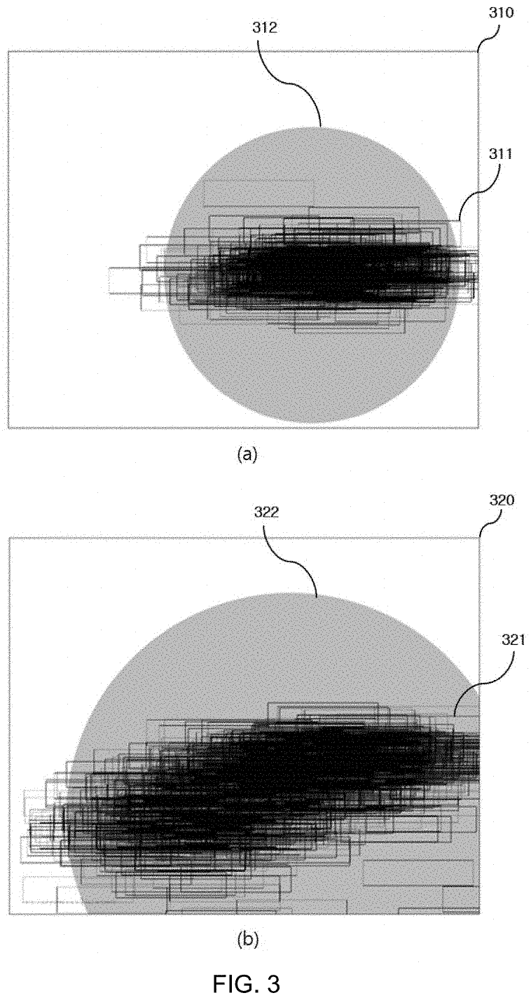

In an embodiment, license plate recognition rate monitoring unit 131 may visualize the score indicating the degree of influence of environmental factors on a license plate recognition rate by using the position information of the received license plate areas. FIG. 3 illustrates examples where the degree of distribution of the license plate areas is visualized by using the acquired position information. The score indicating the degree of influence of environmental factors on a license plate recognition rate will be described in detail with reference to FIG. 3.

It is assumed that as for a parking lot, from which a first image 310 in FIG. 3A is taken, a score indicating the degree of influence of environmental factors on a license plate recognition rate (or score indicating the degree of distribution of license plate areas) is 402 that is lower than a predetermined reference score (threshold value) of 500. In contrast, it is assumed that as for a parking lot, from which a second image 320 in FIG. 3B is taken, the score indicating the degree of influence of environmental factors on a license plate recognition rate is 611 that is higher than the reference score.

An image visualizing a score indicating the degree of influence of environmental factors on a license plate recognition rate (or score indicating the degree of distribution of license plate areas) may display markers indicating the positions of the license plate areas. Referring to FIG. 3A, rectangular markers 311 representing a plurality of license plate areas are displayed as overlapping with one another. It can be seen that most of markers 311 are densely arranged at one point in the entire area and are rarely cropped by the entire area of the vehicle image. However, referring to FIG. 3B, it can be seen that most of markers 321 representing a plurality of license plate areas are widely distributed and are generally cropped by the entire area. The cropped license plate areas cause the license plate recognition to fail.

An image visualizing a score indicating the degree of influence of environmental factors on a license plate recognition rate (or score indicating the degree of distribution of license plate areas) may display a symbol indicating the score. The size of the symbol may be determined by the score. The sizes of symbols 312 and 322 may be determined depending on a score indicating the degree of influence of environmental factors on a license plate recognition rate (or score indicating the degree of distribution of license plate areas, degree of dispersion and density). For example, symbol 312 for first image 310 and symbol 322 for second image 320 may be displayed in circular shape. It can be seen that symbol 312 for first image 310 with a score of 402 is smaller than symbol 322 for second image 320 with a score of 611.

In another embodiment, the color of the symbol may be determined by the score. For example, since symbol 312 for first image 310 has a lower score of 402 than the reference score of 500, it may have a green color meaning that the environmental factors do not influence the recognition rate. Also, since symbol 322 for second image 320 has a higher score of 611 than the reference score of 500, it may have a red color meaning that the environmental factors influence the recognition rate. In another example, the color of the symbol may represent a specific score for each score range or may be displayed using a color gradient based on the score.

Besides, an image visualizing a score indicating the degree of influence of environmental factors on a license plate recognition rate may display various marks related to the license plate recognition rate. Hereinafter, a method of calculating a score indicating the degree of influence of environmental factors on a license plate recognition rate will be described in reverse order by using a visualized image 400. An example of a license plate area will be described.

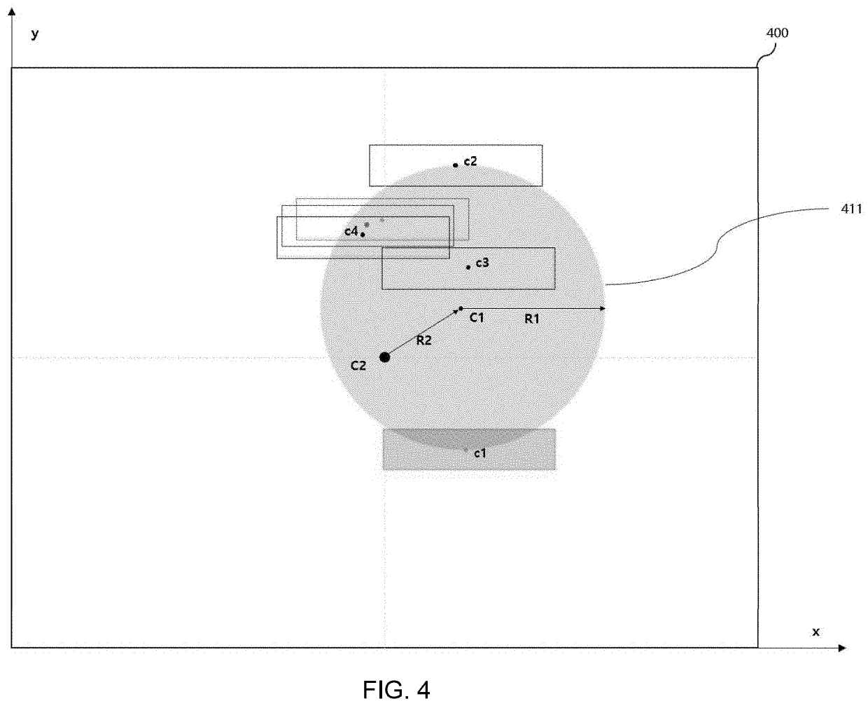

In an embodiment, a score indicating the degree of influence of environmental factors on a license plate recognition rate may be calculated by using position information based on an arbitrary calculation method. For example, a score indicating the degree of influence of environmental factors on a license plate recognition rate may be calculated using the center points of license plate areas. The score indicating the degree of influence of environmental factors on a license plate recognition rate may be calculated by the radius of a circle containing all the center points of the license plate areas and having the smallest size. Table 1 below includes coordinate data of the center points of eight license plate areas, and FIG. 4 visualizes a score indicating the degree of distribution of license plate areas and calculated using the data in Table 1 below.

TABLE 1

| License plate | X-coordinate of | Y-coordinate of |
|---|---|---|
| area | center point | center point |
| 1 | 464 | 225 |
| 2 | 641 | 721 |
| 3 | 618 | 330 |
| 4 | 456 | 349 |
| 5 | 490 | 318 |
| 6 | 641 | 720 |
| 7 | 638 | 405 |
| 8 | 641 | 721 |

Referring to FIG. 4, a plurality of license plate areas is displayed with coordinates of the centers (e.g., c1, c2, c3 and c4), and a circle 411 containing all the centers of the plurality of license plate areas and having the smallest size may be displayed. As an algorithm for obtaining circle 411, for example, the smallest circle problem may be used. In the present embodiment, the coordinates of center C1 of circle 411 can be calculated as [x=629.75, y=473.25] and a radius R1 can be calculated as 248.03 by using the smallest circle problem algorithm. Herein, radius R1 of 248.03, which is calculated using the above algorithm, may be determined as a score indicating the degree of influence of environmental factors on a license plate recognition rate or a score indicating the degree of distribution of license plate areas in the entire area of the image. Alternatively, radius R1 may refer to the degree of dispersion of license plate areas. If this score is higher than the reference score (threshold value), it may mean that a vehicle enters through various routes toward a license plate photographing device. In other words, it may mean that an access pathway to the entrance gate device or the exit gate device is excessively wide and cannot guide the vehicle straight toward the license plate photographing device.

In an additional embodiment, a distance R2 between center C1 of circle 411 derived using the smallest circle problem and center C2 of entire image 400 may be determined as a score indicating the degree of influence of environmental factors on a license plate recognition rate. In the example shown in FIG. 4, distance R2 between center C1 of circle 411 and the coordinates [x=600, y=450] of center C2 of entire image 400 is 37.76. If distance R2 is greater than a predetermined reference score, it may be determined that the viewing direction of the license plate photographing device is not appropriate. In another embodiment, a score indicating the degree of influence of environmental factors on a license plate recognition rate may be determined by at least one or a combination of radius R1 of circle 411 and distance R2 between the centers of circle 411 and the entire image area. For example, the sum of radius R1 and distance R2 between the centers calculated based on the weightings thereof may be determined as a score indicating the degree of influence of environmental factors on a license plate recognition rate.

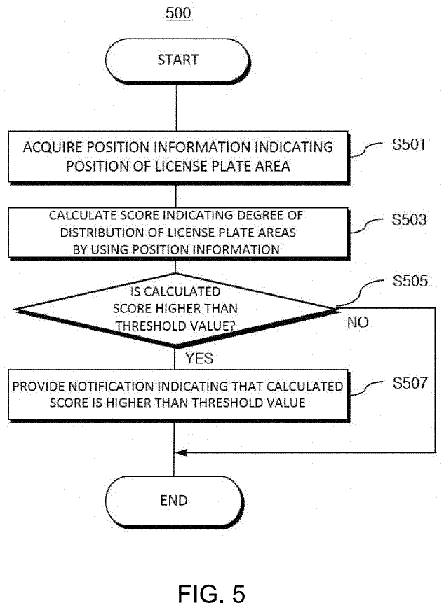

FIG. 5 is an exemplary flowchart of an operation process performed to monitor a license plate recognition rate, in accordance with an embodiment. For example, a process 500 shown in the flowchart may be performed under the control of a computing device included in local parking lot system 110, license plate recognition system 120 and/or license plate recognition rate monitoring server 130 illustrated in FIG. 1.

At a block 501 in process 500, position information indicating positions of license plate areas may be acquired. In an embodiment, position information indicating positions of license plate areas may be acquired in a process of recognizing a vehicle license plate number of a vehicle entering or exiting from a parking lot. In order to recognize a license plate, license plate areas need to be extracted from images of the vehicle, and in the process of extracting the license plate areas, position information indicating positions of the license plate areas may be acquired.

In an embodiment, the acquired position information may be immediately used to calculate a score indicating the degree of distribution of license plate areas and/or may be stored in a memory (or database). A plurality of position information may be accumulated in the memory and may be used to calculate a score indicating the degree of distribution of license plate areas at the request of a user or when accumulated as many as a preset number.

At a block 503 in process 500, the score indicating the degree of distribution of license plate areas may be calculated by using the position information. In other words, at block 503 in process 500, a score indicating the degree of influence of environmental factors on a license plate recognition rate may be calculated by using the position information. The score may be calculated based on at least one of the degree of dispersion or density of the license plate areas, the uniformity of sizes and/or slopes of the license plate areas calculated by using the position information of the license plate areas. In an embodiment, the process of calculating the score may be performed whenever position information is acquired. In other words, if a new image is taken and position information of a license plate area in the new image is acquired when a new vehicle enters or exits from the parking lot, a score reflecting the position information of the new image may be newly updated. In another embodiment, in the process of calculating the score, the score reflecting the position information may be newly updated. In another embodiment, a score reflecting position information may be newly updated. In another embodiment, when position information of a license plate area in a new image is acquired, the generated position information is accumulated in the database, and when the position information is accumulated as many as a preset number, a score may be calculated by using the position information accumulated as many as the preset number. Also, in another embodiment, the process of calculating the score may be performed at the request of the user, or may be performed at predetermined time intervals.

At a block 505 in process 500, whether the calculated score is higher than a threshold value (e.g., reference score) may be checked. The threshold value (reference score) may be determined in advance by the user (e.g., parking management system provider).

When the calculated score is lower than the threshold value as a result of checking at block 505, process 500 may be ended, and when it is higher than the threshold value, a notification indicating that the license plate recognition rate is lower than the reference score may be generated. In other words, process 500 may provide the user with a notification indicating that the calculated score is higher than the threshold value when the calculated score is higher than the threshold value. In an embodiment, the notification may be provided to the user through an output device. For example, the calculated score may be displayed on a graphic user interface (GUI) of an application program on a display included in the output device. For another example, an image visualized from the calculated score (e.g., first image 310 in FIG. 3A or second image 320 in FIG. 3B) may be displayed on the GUI of the display. For yet another example, a sound (e.g., voice or notification sound) indicating that the calculated score is higher than the threshold value may be output through a speaker.

The output device may be connected to at least one of local parking lot system 110, license plate recognition system 120 and license plate recognition rate monitoring server 130. For example, the output device may be connected to local parking system 110 and provided at a place where local parking system 110 is installed so that a user using the parking management system can receive a notification about a license plate recognition rate. For another example, the output device may be connected to license plate recognition rate monitoring server 130 and provided at a place where license plate recognition rate monitoring server 130 is provided so that a service provider providing the parking management system can receive a notification about a license plate recognition rate. In another embodiment, process 500 may further include a block where at least one of an image taken when the vehicle license plate number is not recognized, a license plate area and position information of the license plate area is provided to the user. For example, when a score is higher than the reference score, an image taken when the vehicle license plate number is not recognized may be provided to the user automatically or at the request of the user through the output device. In that case, the image taken when the vehicle license plate number is not recognized may be labeled or classified separately in the process of recognizing the vehicle license plate number and then stored in the database (e.g., database 122 in FIG. 1).

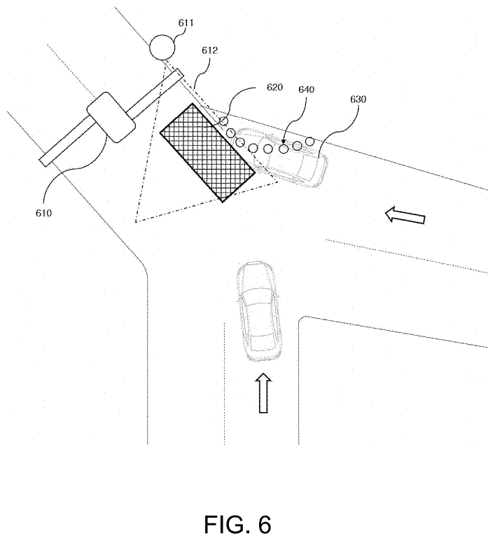

FIG. 6 is a conceptual diagram illustrating an exemplary environment where an image of a license plate is taken when a vehicle enters a parking lot. Referring to FIG. 6, an entrance gate device (or exit gate device) 610 may be installed in an entry pathway (or exit pathway) of a local parking lot. Entrance gate device 610 may include a photographing device 611 configured to photograph a license plate of an incoming vehicle.

Photographing device 611 may have a viewing angle 612 depending on the installed height or direction. If photographing device 611 is installed at a wrong height and/or in a wrong direction, license plates of incoming vehicles may not be included in viewing angle 612 in many cases, and a license plate recognition rate may decrease. In that case, by adjusting the viewing direction of photographing device 611, the decrease in the license plate recognition rate can be overcome.

Also, if the incoming vehicle is not guided straight toward photographing device 611, license plate areas may not be included in viewing angle 612 or may be cropped by photographing device 611 in many cases, and the license plate recognition rate may decrease. FIG. 6 illustrates a situation where a vehicle 630 deviates from viewing angle 612 of photographing device 611 and approaches entry or exit gate device 610 due to the excessively wide access pathway. In that case, a structure 640 such as road pillars may be installed to guide vehicle 630 through a straight pathway 620 toward photographing device 611, and, thus, the decrease in the license plate recognition rate can be overcome.

Hereinafter, an operation of automatically analyzing a cause (situation) of a low license plate recognition rate by the vehicle license plate recognition rate monitoring system of the present disclosure when a score indicating the degree of influence of environmental factors on a license plate recognition rate is higher than the reference score will be described.

In an additional embodiment, process 500 shown in FIG. 5 may further include a block where a cause of a low license plate recognition rate if it is determined that the license plate recognition rate is lower than the reference score. It may be performed by an artificial intelligence system (e.g., recognition rate analysis intelligent platform 132 in FIG. 1) that analyzes a cause of a low license plate recognition rate. The artificial intelligence system may be a rule-based system, or may be a neural network-based system (e.g., feedforward neural network (FNN), recurrent neural network (RNN), generative adversarial networks (GAN)). Otherwise, the artificial intelligence system may be a combination of the above or another artificial intelligence system. The artificial intelligence system may generate a learning model based on images and/or position information acquired when a license plate cannot be recognized or is misrecognized and may learn a cause of a low license plate recognition rate. Examples of inputs (causes) and outputs (results) required to generate a learning model are as follows. From the result of analyzing a cause of a low license plate recognition rate, environmental factors such as an abnormality in the access pathway for a vehicle, an error in the viewing direction of a camera installed in the entrance or exit gate device, etc. may be derived. As described above, for example, if it is analyzed that the size or slope of the license plate area is often exceptionally large, it may be determined that the speed of the vehicle moving toward the gate device is higher than an appropriate speed. For another example, if it is analyzed that the license plate area is often excessively cropped (e.g., if distance R2 in FIG. 4 is greater than a reference distance), it may be determined that the viewing direction of the camera is not appropriate. For yet another example, if it is analyzed that the license plate areas are often irregularly distributed (e.g., if distance R1 in FIG. 4 is greater than a reference distance), it may be determined that the access pathway for the vehicle is excessively wide. In an embodiment, the artificial intelligence system learns position information of license plate areas and/or changes or analysis result of scores that can be calculated from the position information and thus can analyze and provide a cause of a decrease in a license plate recognition rate just with the position information of the license plate areas and/or the scores that can be calculated from the position information.

The user who has received the analysis result from the artificial intelligence system may install a speed bump on the access pathway for the vehicle, change the viewing direction of the photographing device or install road pillars on the entry and exit pathway to guide the vehicle to an appropriate route. Thus, it is possible to improve a license plate recognition rate.

The artificial intelligence system may provide the user with the result of analyzing a cause of a low license plate recognition rate separately from or together with a notification indicating that the recognition rate is lower than a reference level.

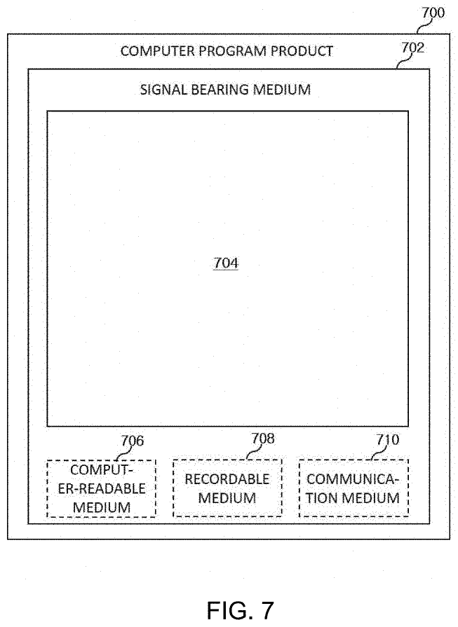

FIG. 7 illustrates an exemplary computer program product 700 that can be used for monitoring a license plate recognition rate, in accordance with at least some embodiments of the present disclosure. Exemplary computer program product 700 is provided by using, for example, a signal bearing medium 702. In some embodiments, one or more signal bearing mediums 702 of a computer program product 900 may include a computer-readable medium 706, a recordable medium 708 and/or a communication medium 710.

Instructions 704 included in signal bearing medium 702 may be executed by computing devices such as local parking lot system 110, license plate recognition system 120 and/or license plate recognition rate monitoring server 130 illustrated in FIG. 1. When executed, instructions 704 may cause the computing devices to perform operations for monitoring a license plate recognition rate.

For example, instructions 704 may include an instruction to acquire a plurality of position information indicating positions of license plate areas in a plurality of images, an instruction to calculate a score indicating the degree of distribution of license plate areas in the entire area of the image by using the acquired plurality of position information, and instruction to transmit a notification indicating that the score is higher than a threshold value when the score is higher than the threshold value.

The above description of the present disclosure is provided for the purpose of illustration, and it would be understood by a person with ordinary skill in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The claimed subject matter is not limited in scope to the particular implementations described herein. For example, some implementations may be in hardware, such as employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. This storage media, such as CD-ROMs, computer disks, flash memory, or the like, for example, may have instructions stored thereon, that, when executed by a computing device, such as a computing system, computing platform, or other system, for example, may result in execution of a processor in accordance with the claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive.

There is little distinction left between hardware and software implementations of aspects of systems; the use of hardware or software is generally a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed.

For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative example of the subject matter described herein applies regardless of the particular type of signal bearing medium used to actually carry out the distribution.

While certain example techniques have been described and shown herein using various methods and systems, it should be understood by those skilled in the art that various other modifications may be made, and equivalents may be substituted, without departing from claimed subject matter.

Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

Throughout this document, the term “connected to” may be used to designate a connection or coupling of one element to another element and includes both an element being “directly connected to” another element and an element being “electronically connected to” another element via another element. Through the whole document, the term “on” that is used to designate a position of one element with respect to another element includes both a case that the one element is adjacent to the other element and a case that any other element exists between these two elements. Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise. Through the whole document, the term “about or approximately” or “substantially” is intended to have meanings close to numerical values or ranges specified with an allowable error and intended to prevent accurate or absolute numerical values disclosed for understanding of the present disclosure from being illegally or unfairly used by any unconscionable third party.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. A method for monitoring a license plate recognition rate that is performed by at least one computing device, comprising:
acquiring a plurality of position information indicating positions of license plate areas in a plurality of images;
calculating a score indicating the degree of distribution of the license plate areas in the entire area of the image by using the acquired plurality of position information; and
generating a notification indicating that the license plate recognition rate is lower than a reference level when the score is higher than a threshold value.

2. The method for monitoring a license plate recognition rate of claim 1, further comprising:
acquiring position information of a new image; and
updating the score by using the position information of the new image.

3. The method for monitoring a license plate recognition rate of claim 2,
wherein the score is calculated by using a plurality of position information recently acquired as many as a preset number.

4. The method for monitoring a license plate recognition rate of claim 1,
wherein the score is calculated based on at least one of the degree of dispersion, density, and size and slope of the license plate areas.

5. The method for monitoring a license plate recognition rate of claim 1, further comprising:
taking the plurality of images including the license plate areas;
extracting the license plate area from each of the plurality of images; and
recognizing a vehicle license plate number from the extracted license plate area,
wherein the plurality of position information indicating the positions of the license plate areas is generated in the process of extracting the license plate areas from the plurality of images.

6. A server for monitoring a license plate recognition rate, comprising:
at least one processor connected to a photographing device; and
a memory operatively connected to the at least one processor,
wherein the memory includes instructions that, when executed, causes the at least one processor:
to acquire a plurality of position information indicating positions of license plate areas in a plurality of images;
to calculate a score indicating the degree of distribution of the license plate areas in the entire area of the image by using the acquired plurality of position information; and
to generate a notification indicating that the license plate recognition rate is lower than a reference level when the score is higher than a threshold value.

7. A computer program stored in a computer-readable recording medium for monitoring a license plate recognition rate, comprising:
one or more computer-executable instructions that, when executed by a computing device, cause the computing device to perform:
acquiring a plurality of position information indicating positions of license plate areas in a plurality of images;
calculating a score indicating the degree of distribution of the license plate areas in the entire area of the image by using the acquired plurality of position information; and
transmitting a notification indicating that the score is higher than a threshold value when the score is higher than the threshold value.
